(19) United States
(12) Patent Application Publication
(10) Pub. No.: US 2008/0111898 A1
(43) Pub. Date: May 15, 2008

(54) Driver and driving method for solid-state imaging device

(75) Inventors: Yoshiyuki Tomizawa, Yokohama-shi (JP); Toshiaki Utsumi, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/976,044

(22) Filed: Oct. 19, 2007

(30) Foreign Application Priority Data
Nov. 10, 2006 (JP) 2006-305504

(51) Int. Cl. H04N 5/76; H04N 5/335

(52) U.S. Cl. 348/231.99; 348/294; 348/E05.031; 348/E05.091

(57) ABSTRACT

According to one embodiment the amount of noise in the OB interval of a video signal when an electron-multiplying solid-state imaging device is driven with each of predetermined multiplication gains has been measured and stored in advance. The amount of noise in the OB interval of a video signal when the solid-state imaging device is driven with a drive voltage of a predetermined magnitude is measured. The magnitude of the drive voltage is corrected on the basis of the measured amount of noise and the stored amount of noise corresponding to one of the predetermined multiplication gains.

### CROSS-REFERENCE TO RELATED APPLICATIONS

This application is based upon and claims the benefit of priority from Japanese Patent Application No. 2006-305504, filed Nov. 10, 2006, the entire contents of which are incorporated herein by reference.

### BACKGROUND

1. Field

One embodiment of the invention relates to a driver and driving method for an electron-multiplying solid-state imaging device.

2. Description of the Related Art

As is well known, an electron-multiplying solid-state imaging device is capable of varying its multiplication gain according to the magnitude of a drive voltage applied to its multiplication section. With such an electron-multiplying solid-state imaging device, the multiplication gain may gradually decrease with time or according to the conditions under which it is actually used even if the magnitude of a drive voltage applied to it remains unchanged.

It is presently considered that the occurrence of gain variations results from electrons which should increase in number through electron multiplication ceasing to increase with time or according to the conditions under which the imaging device is actually used. For this reason, with an electron-multiplying solid-state imaging device which has long been used, even when it is supplied with a drive voltage of the same magnitude as at the early time of use, it becomes impossible to attain the same amplification gain as at that time.

JP-A 2003-347317 (KOKAI) discloses the configuration of a charge multiplying device (CMD) and a CMD-mounting charge coupled device (CCD) layer which allow the charge multiplication factor to be arbitrarily adjusted by adjusting the cycle and the number of times of a drive voltage of the first phase to perform charge multiplication through impact ionization in comparison with multi-phase drive voltages.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram for use in explanation of a monitor camera according to an embodiment of the present invention;

FIG. 2 is a block diagram of the signal processing system of a color camera used in the monitor camera of the embodiment;

FIG. 3 is a characteristic diagram for use in explanation of gain variations with time of the electron-multiplying CCD used in the color camera of the embodiment;

FIG. 4 is a characteristic diagram for use in explanation of gain variations of the electron-multiplying CCD used in the color camera of the embodiment when different multiplication gains are set in the CCD;

FIG. 5 is a characteristic diagram for use in explanation of gain variations of the electron-multiplying CCD used in the color camera of the embodiment when the CCD has different saturated areas;

FIGS. 6A to 6C are diagrams for use in explanation of the measurement of the amount of noise in the optical black (OB) interval of a digital video signal which is made by the control unit used in the color camera of the embodiment; and

FIG. 7 is a flowchart illustrating the gain variation compensation processing performed by the control unit used in the color camera of the embodiment.

### DETAILED DESCRIPTION

Various embodiments according to the invention will be described hereinafter with reference to the accompanying drawings. In general, according to one embodiment of the invention, the amount of noise in the OB interval of a video signal when an electron-multiplying solid-state imaging device is driven with each of predetermined multiplication gains has been measured and stored in advance. The amount of noise in the OB interval of a video signal when the solid-state imaging device is driven with a drive voltage of a predetermined magnitude is measured. The magnitude of the drive voltage is corrected on the basis of the measured amount of noise and the stored amount of noise corresponding to one of the predetermined multiplication gains.

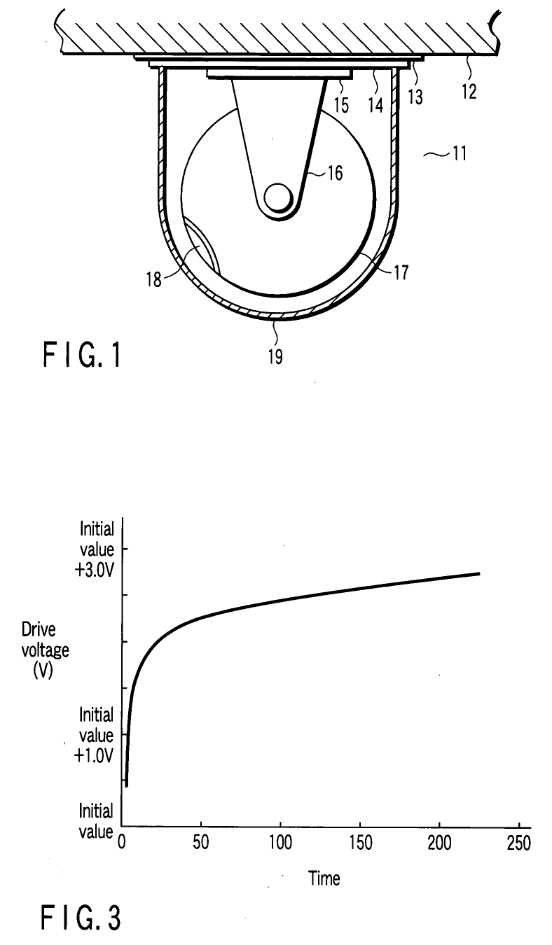

FIG. 1 schematically shows a monitoring camera 11 which will be described in this embodiment. The monitoring camera 11 is mounted, for example, on the ceiling 12 of a building with a mounting plate 13. The mounting plate 13 is fitted with a supporting plate 14, which is fitted at its center with a rotating plate 15.

The rotating plate 15 is fitted with a pair of supports 16 (only one is illustrated in FIG. 1) with its center of rotation interposed therebetween, the supports extending downward in the drawing. A color camera 17, which is virtually formed in the shape of a globe, is rotatably mounted between the paired supports 16. In this case, the color camera 17 has a lens 18 exposed in a portion of its globe-like casing.

With the color camera 17 thus mounted, its lens 18 can be moved in the pan direction by rotating the rotating plate 15 and in the tilt direction by rotating the camera itself. In this case, the rotating plate 15 and the color camera 17 are rotated by a pan motor and a tilt motor, respectively, which are not shown in FIG. 1.

The color camera 17 is covered with a transparent cover 19. The cover 19 has its one end portion formed in the shape of a semi-globe in correspondence with the shape of the color camera 17 and its other end portion formed in the shape of an open cylinder. The cover 19 covers the color camera 17 in such a way that the camera is housed in it and its open end is attached to the periphery of the supporting plate 14.

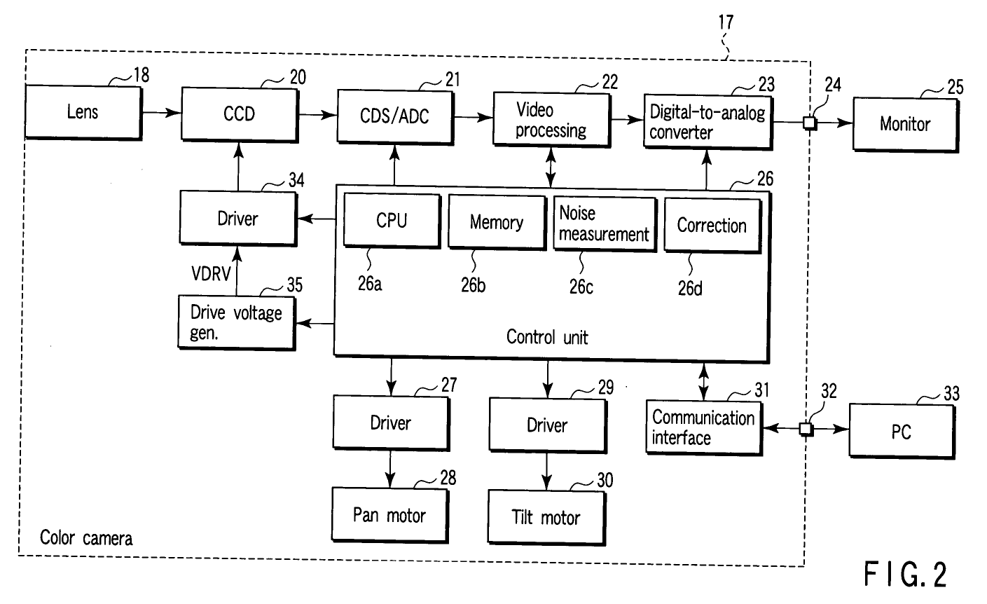

FIG. 2 shows the signal processing system of the color camera 17. An incoming optical image of a subject produced by the lens 18 is captured on an electron-multiplying CCD 20 and then converted into an electrical signal corresponding to that optical image. The electrical signal output from the CCD 20 undergoes noise reduction and digitization processing in a correlated double sampling/analog-to-digital conversion (CDS/ADC) unit 21. The resulting digital video signal is then applied to a video processing unit 22 where it undergoes predetermined video signal processing.

In the video processing unit 22, the input digital video signal undergoes video signal processing, such as sharpness processing, contrast processing, gamma correction processing, white balance processing, white pixel compensation processing, compression processing, etc. The video signal output from the video processing unit 22 is converted into analog form by a digital-to-analog conversion (DAC) unit 23 and then applied through an output terminal 24 to an external monitor 25 for visual display.

All the operations of the color camera 17 including the above image capture operation are controlled by a control unit 26. The control unit 26 has a central processing unit (CPU) 26a built in and responds to control information from a personal computer (PC) 33 to be described later to control each component so that the contents of control are reflected.

In this case, the control unit 26 employs a memory unit 26b. The memory unit 26b includes a read-only memory (ROM) containing a control program to be executed by the CPU 26a, a random access memory (RAM) which provides the CPU 26a with a working area, and a nonvolatile memory containing various items of configuration and control information.

In addition, the control unit 26 is adapted to drive the aforementioned pan motor 28 through a driver 27. In this case, the control unit 26 is able to control the direction and speed of rotation of the pan motor 27. Furthermore, the control unit 26 is adapted to drive the aforesaid tilt motor 30 through a driver 29. In this case, the control unit 26 is able to control the direction and speed of rotation of the tilt motor 30.

The control unit 26 is connected through a communication interface (I/F) 31 and an input/output terminal 32 to the PC 33. Thereby, the control unit 26 is allowed to send a digital video signal which has been processed by the video processing unit 22 to the PC 33 for visual display on it as well as to control each component on the basis of control information supplied from the PC 33.

The control unit 36 controls a drive unit 34 for driving the CCD 20. The drive unit 34 drives the CCD 20 with a multiplication gain corresponding to the magnitude of a drive voltage VDRV output from a drive voltage generating unit 35. The control unit 26 controls the magnitude of the drive voltage VDRV output from the drive voltage generating unit 35 so that the multiplication gain required by the PC 33 is attained.

In view of gain variations of the CCD 20 which occur with time or according to the conditions where the camera is actually used, the control unit 26 is equipped with a noise amount measurement unit 26c and a correction unit 26d to correct the magnitude of the drive voltage VDRV from the drive voltage generating unit 35 so that the multiplication gain required by the user is correctly attained at all times even if gain variations occur.

That is, with the electron-multiplying CCD 20, it is known that gain variations occur, i.e., its multiplication gain gradually decreases with time or according to the conditions where it is actually used even if the magnitude of the applied drive voltage VDRV remains unchanged. In this case, as the conditions where the camera is actually used, the required multiplication gain and the number of pixels which are in the saturated state (the saturated area) significantly affect the gain variations.

FIG. 3 shows a measurement illustrating the relationship between the magnitude of the drive voltage VDRV required to attain a constant multiplication gain and the time. It can be seen that the same gain cannot be attained unless the magnitude of the drive voltage VDRV is increased with time.

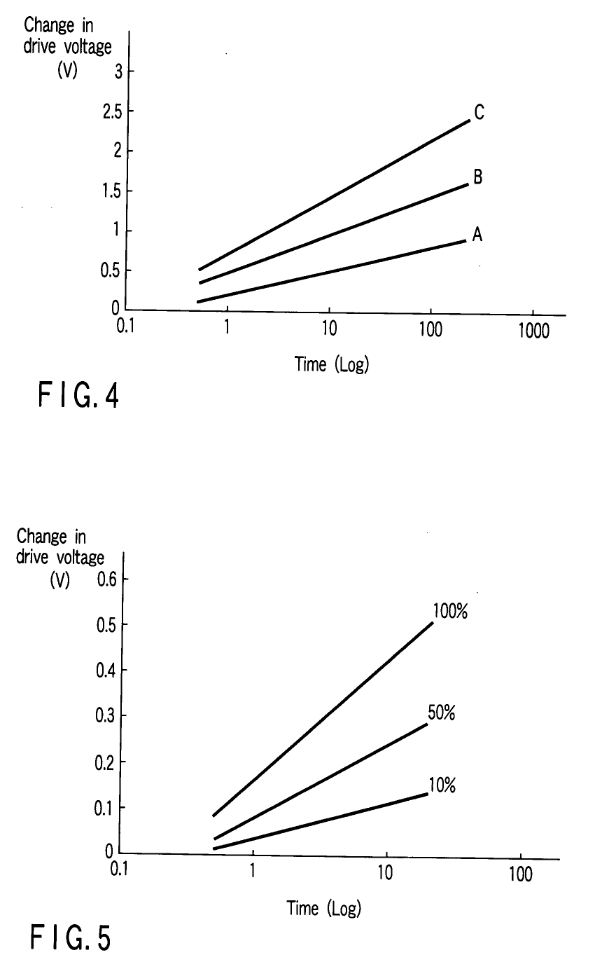

FIG. 4 shows a measurement in which, with three multiplication gains set by drive voltages A, B and C (A<B<C), the change in each of the multiplication gains with time is expressed in terms of the change in drive voltage required to maintain the corresponding set gain. It can be seen that the higher the multiplication gain, i.e., the higher the drive voltage, the greater the change in gain becomes.

FIG. 5 shows a measurement in which, when the saturated area makes up 100%, 50% and 10% of the total pixels of the CCD 20, the change in multiplication gain with time is expressed in terms of the change in drive voltage required to maintain the same gain. It can be seen that the larger the saturated area, the greater the change in gain becomes.

In this embodiment, when the color camera 17 is first requested to capture an image with a predetermined multiplication gain (for example, 1,000, 500, 250, . . . ), the control unit 26 causes the drive voltage generating unit 35 to generate a drive voltage VDRV of a previously set magnitude corresponding to that multiplication gain and apply it to the CCD 20. At this point, the control unit 26 measures, through its noise measuring unit 26c, the amount of noise in the optical black (OB) interval of a digital video signal actually obtained from the CDS/ADC unit 21.

On the other hand, the multiplication gain varies from CCD to CCD even if the same drive voltage is applied. In the camera factory, therefore, gain matching is performed at the stage of adjustment in such a way that the magnitudes of drive voltages required to attain specified multiplication gains (for example, 1,000, 500, 250, . . . ) of the CCD 20 are set for each color camera.

In the factory, at the stage of adjusting the multiplication gains, the amount of noise in the OB interval of a digital video signal actually obtained from the CDS/ADC unit 21 is measured for each of the multiplication gains (for example, 1,000, 500, 250, . . . ). The measured amounts of noise are then stored in the memory unit 26b as reference values.

The control unit 26 corrects the magnitude of a drive voltage VDRD being generated from the drive voltage generating unit 35 in the correction unit 26d by comparing the current amount of noise being measured by the noise measuring unit 26c with the noise reference values stored in the memory unit 26b so that a currently required multiplication gain is attained, namely, the current amount of noise coincides with one of the reference values, thereby compensating for a decrease in the multiplication gain of the CCD 20.

Assuming that the amount of noise in the OB interval of a digital video signal when no electron multiplication is required (electron multiplication is off) is N, the amount of noise in the OB interval of the digital video signal when predetermined electron multiplication is required (electron multiplication is on) is Nem, and the multiplication gain is Gem, the following relation holds:
Nem∝Gem×N

That is to say, this embodiment employs the fact that measuring Nem allows us to know the actual multiplication gain Gem.

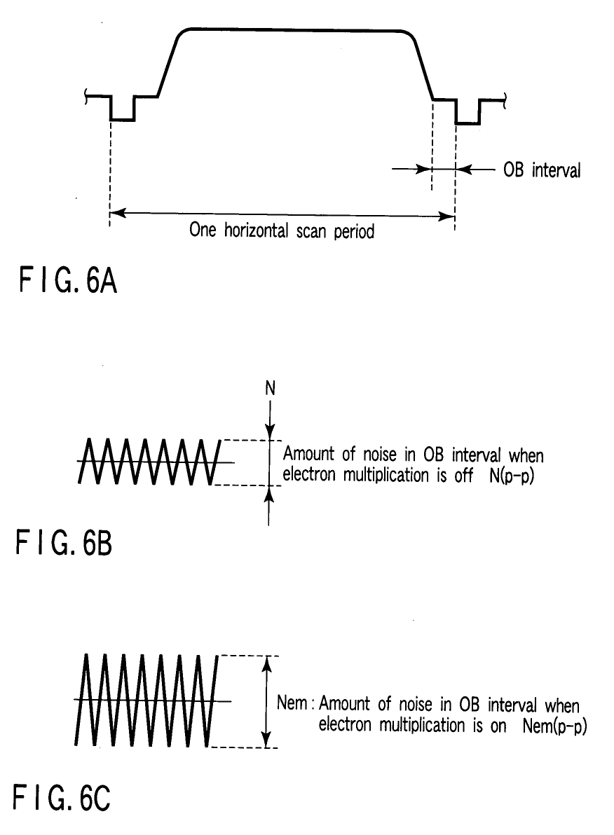

In short, the embodiment employs the fact that noise in the OB interval within one horizontal scan period of a digital video signal actually obtained from the CDS/ADC unit 21 as shown in FIG. 6A is also subjected to electron multiplication. The amount of noise, N, in the OB interval when electron multiplication is off is expressed in terms of the peak-to-peak amplitude value in the OB interval as shown in FIG. 6B. The amount of noise, Nem, in the OB interval when electron multiplication is on is expressed in terms of the peak-to-peak amplitude value in the OB interval as shown in FIG. 6C.

With the measurement of the amount of noise based on data in only one horizontal scan period, the accuracy is poor due to the influence of random noise. For this reason, measurements are made over tens of horizontal scan periods to one vertical scan period and the measurements are averaged, thereby enhancing the accuracy.

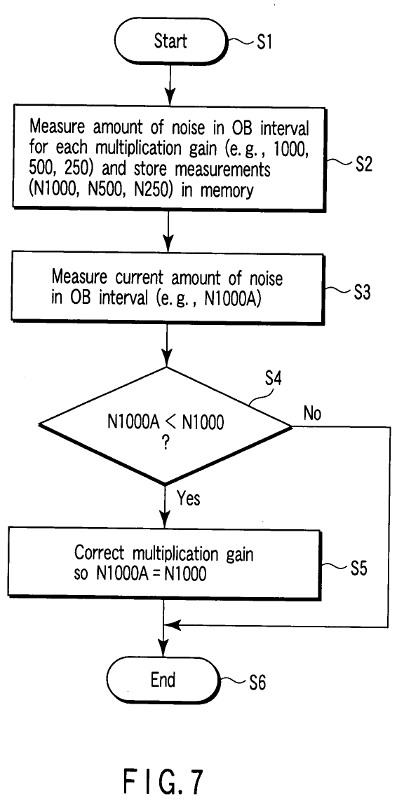

FIG. 7 is a flowchart for the aforementioned multiplication gain correction processing. That is, when the processing is started (step S1) at the stage of multiplication gain adjustment at the factory, the amount of noise in the OB interval of a digital video signal from the CDS/ADC unit 21 is measured for each of the multiplication gains (for example, 1,000, 500, 250, . . . ) and then the measurements (N1000, N500, N250, . . . ) are stored in the memory unit 26b as reference values (step S2).

After that, when electron multiplication is required at the time of actual image capture, the control unit 26 drives the CCD 20 with a drive voltage VDRV of a preset magnitude corresponding to the required multiplication gain (for example, 1,000) and measures the amount of noise, N1000A (actual), in the OB interval of a digital video signal from the CDS/ADC unit 21 (step S3).

The control unit 26 then makes a comparison between the amount of noise, N1000A, in the OB interval of the digital video signal and the amount of noise, N1000, stored in the memory unit 26b for the same multiplication gain (1,000) to decide whether or not N1000A<N1000 (step S4).

If NO in step S4, then the control unit 26 decides that the multiplication gain of the CCD 20 has not decreased and continues to drive the CCD 20 with the aforesaid preset drive voltage VDRV with the result that the procedure is complete (step S6).

If, on the other hand, YES in step S4, i.e., N1000A<N1000, then the control unit 26 decides that the multiplication gain of the CCD 20 has decreased and then corrects the multiplication gain so that N1000A becomes equal to N1000 (step S5), thereby completing the procedure (step S6).

According to the embodiment described above, the amount of noise, A, in the OB interval of a digital video signal actually obtained when the CCD is driven by the drive voltage corresponding to a required multiplication gain is compared with the amount of noise, B, in the OB interval which has been stored in the memory unit 26b as a reference value when the CCD was driven with that multiplication gain and, when A<B, the multiplication gain is corrected so that A=B. Even if gain variations occur with time or according to the conditions in which the color camera is actually used, therefore, it becomes possible to compensate for the gain variations in real time, allowing the electron-multiplying CCD 20 to be driven at all times with a required multiplication gain.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A driver for a solid-state imaging device comprising:
a generating unit configured to generate a drive voltage having a magnitude to obtain a predetermined multiplication gain to an electron-multiplying solid-state imaging device;
a producing unit configured to produce a video signal on the basis of an output signal of the solid-state imaging device which is driven with a drive voltage output from the generating unit;
a storage unit configured to store the amount of noise in the OB (optical black) interval of a video signal obtained from the producing unit when the solid-state imaging device is driven with each of a plurality of predetermined multiplication gains;
a measurement unit configured to measure the amount of noise in the OB interval of a video signal obtained from the producing unit when the solid-state imaging device is driven with a drive voltage corresponding to one of the predetermined multiplication gains; and
a correction unit configured to correct the magnitude of the drive voltage output from the generating unit on the basis of the amount of noise measured by the measuring unit and the amount of noise stored in the storage unit and corresponding to the one of the predetermined multiplication gains.

2. The driver according to claim 1, wherein the correction unit corrects the magnitude of the drive voltage output from the generating unit so that the amount of noise measured by the measuring unit coincides with the amount of noise stored in the storage unit and corresponding to the one of the predetermined multiplication gains.

3. The driver according to claim 1, wherein the amount of noise is expressed in terms of a peak-to-peak amplitude value obtained in the OB interval of the video signal output from the producing unit.

4. The driver according to claim 3, wherein the correction unit corrects the magnitude of the drive voltage output from the generating unit so that the peak-to-peak amplitude value measured by the measuring unit coincides with the peak-to-peak amplitude value stored in the storage unit and corresponding to the one of the predetermined multiplication gains.

5. The driver according to claim 3, wherein the correction unit makes a comparison between the peak-to-peak amplitude value measured by the measuring unit and the peak-to-peak amplitude value stored in the storage unit and corresponding to the one of the predetermined multiplication gains and, when the former peak-to-peak amplitude value is lower than the latter, corrects the magnitude of the drive voltage output from the generating unit so that the former becomes equal to the latter.

6. A color camera equipped with an electron-multiplying solid-state imaging device comprising:
a generating unit configured to generate a drive voltage having a magnitude to obtain a predetermined multiplication gain to the solid-state imaging device;
a producing unit configured to produce a video signal on the basis of an output signal of the solid-state imaging device which is driven with a drive voltage output from the generating unit;
a processing unit configured to perform predetermined signal processing on the video signal output from the producing unit;
a storage unit configured to store the amount of noise in the optical black (OB) interval of a video signal output from the producing unit when the solid-state imaging device is driven with each of a plurality of predetermined multiplication gains;
a measurement unit configured to measure the amount of noise in the OB interval of a video signal output from the producing unit when the solid-state imaging device is driven with a drive voltage corresponding to one of the predetermined multiplication gains; and
a correction unit configured to correct the magnitude of the drive voltage output from the generating unit on the basis of the amount of noise measured by the measuring unit and the amount of noise stored in the storage unit and corresponding to the one of the predetermined multiplication gains.

7. For use with a color camera equipped with an electron-multiplying solid-state imaging device, a drive voltage generating unit configured to supply the solid-state imaging device with a drive voltage having a magnitude to obtain a predetermined multiplication gain, and a video signal producing unit configured to produce a video signal on the basis of an output signal of the solid-state imaging device driven with the drive voltage output from the generating unit, a method of driving the solid-stage imaging device comprising:
storing the amount of noise in the optical black (OB) interval of a video signal output from the producing unit when the solid-state imaging device is driven with each of a plurality of predetermined multiplication gains;
measuring the amount of noise in the OB interval of a video signal output from the producing unit when the solid-state imaging device is driven with a drive voltage corresponding to one of the predetermined multiplication gains; and
correcting the magnitude of the drive voltage output from the generating unit on the basis of the amount of noise measured by the measuring unit and the amount of noise stored in the storage unit and corresponding to the one of the predetermined multiplication gains.

8. The method according to claim 7, wherein the magnitude of the drive voltage output from the generating unit is corrected so that the measured amount of noise coincides with the stored amount of noise corresponding to the one of the predetermined multiplication gains.

9. The method according to claim 7, wherein the amount of noise is expressed in terms of a peak-to-peak amplitude value obtained in the OB interval of the video signal output from the producing unit.

10. The method according to claim 9, wherein the magnitude of the drive voltage output from the generating unit is corrected so that the measured peak-to-peak amplitude value coincides with the stored peak-to-peak amplitude value corresponding to the one of the predetermined multiplication gains.

11. The method according to claim 9, wherein the magnitude of the drive voltage is corrected by making a comparison between the measured peak-to-peak amplitude value and the stored peak-to-peak amplitude value corresponding to the one of the predetermined multiplication gains and, when the former peak-to-peak amplitude value is lower than the latter, correcting the magnitude of the drive voltage output from the generating unit so that the former becomes equal to the latter.
